(19) United States
(12) Patent Application Publication
(10) Pub. No.: US 2003/0215766 A1
(43) Pub. Date: Nov. 20, 2003

(54) Light emitting systems and kits that include a light emitting device and one or more removable lenses

(75) Inventors: Dan E. Fischer, Sandy, UT (US); Bruce S. McLean, Sandy, UT (US); Vasiliy Nosov, Sandy, UT (US)

Correspondence Address: Rick D. Nydegger, WORKMAN, NYDEGGER & SEELEY, 1000 Eagle Gate Tower, 60 East South Temple, Salt lake City, UT, 84111, US

(73) Assignee: Ultradent Products, Inc.

(21) Appl. No.: 10/423,275

(22) Filed: Apr. 25, 2003

Related U.S. Application Data
(63) Continuation-in-part of application No. 10/068,103, filed on Feb. 5, 2002.
(63) Continuation-in-part of application No. 10/044,346, filed on Jan. 11, 2002.
(63) Continuation-in-part of application No. 10/068,397, filed on Feb. 5, 2002, now abandoned.
(63) Continuation-in-part of application No. 10/328,510, filed on Dec. 23, 2002.

(51) Int. Cl. A61C 3/00

(52) U.S. Cl. 433/29

(57) ABSTRACT

A light emitting system for curing light curable compositions, illuminating tissue, or other uses includes a light emitting device having an LED light source configured to emit radiant energy and one or more detachable lenses. The detachable lens may be a cone-shaped lens, a collimating lens, a diffusing lens, a spot curing lens, or a diagnostic lens. The light emitting device and a plurality of different lenses can be packaged together as a kit.

### CROSS-REFERENCE TO RELATED APPLICATIONS

This application is a continuation-in-part of U.S. application Ser. No. 10/068,103, filed Feb. 5, 2002, and entitled “Lightweight Hand Held Dental Curing Device”; and a continuation-in-part of U.S. application Ser. No. 10/044,346, filed Jan. 11, 2002, and entitled “Optical Lens Used to Focus LED Light”; and a continuation-in-part of U.S. application Ser. No. 10/068,397, filed Feb. 5, 2002, and entitled “Curing Light With Plurality of LEDs and Corresponding Lenses Configured to Focus Light”; and a continuation-in-part of U.S. application Ser. No. 10/328,510, filed Dec. 23, 2002 entitled “Cone-Shaped Lens Having Increased Forward Light Intensity and Kits Incorporating Such Lenses”; and a continuation-in-part of U.S. application Ser. No. ______, filed Apr. 4, 2003, and entitled “Illumination Apparatus for Enhancing Visibility of Oral Tissues”; and a continuation-in-part of U.S. application Ser. No. ______, filed Apr. 25, 2003, and entitled “Spot Curing Lens Used to Spot Cure a Dental Appliance Adhesive and Systems and Methods Employing Such Lenses.” For purposes of disclosure, the foregoing applications are incorporated by reference in their entirety.

### BACKGROUND OF THE INVENTION

1. The Field of the Invention

The present invention is in the field of light emitting systems and kits and, more particularly, to the field of light emitting devices that include LED light sources and lenses that may be releasably attached to the light emitting devices.

2. The Relevant Technology

In the dental industry, dental cavities are often filled or sealed with photosensitive compositions that are cured by exposure to radiant energy, such as visible light. These compositions, commonly referred to as light-curable compositions, are placed within dental cavity preparations or onto dental surfaces where they are subsequently irradiated by light. The radiated light causes photosensitive components within the compositions to polymerize, thereby hardening the light-curable compositions within the dental cavity preparation or another desired location.

The light is typically directed to the light-curable compositions with a light-curing device that includes a lamp, such as a halogen lamp bulb, that is configured to generate light within a spectrum suitable for curing the light-curable dental compositions. Conventional light curing devices may include a light guide, such as a fiber optic wand or a specialized tip that can capture or otherwise redirect the light within the patient's mouth, where the light is finally emitted.

Light emitting diodes (LEDs) are another light source that may have application in connection with dental curing lights. Compared to halogen lamp bulbs, LEDs are relatively cool and more efficient. Although LEDs are a possible light source that can be used to cure light-curable dental compositions, there is an ongoing need to find ways of protecting LEDs from being contaminated by light curable compositions and/or to alter or improve the light that is emitted by an LED to yield a device that is more versatile and capable of serving the needs of dental practitioners.

### SUMMARY OF THE INVENTION

The present invention encompassing light emitting systems and kits that can be used in light-curable compositions, for tissue illumination and the like. The light emitting systems and kits include a light emitting device having an LED light source configured to emit radiant energy and one or more lenses that may be detachably connected to the light emitting device. The detachable lenses that form part of the light emitting systems and kits may comprise one or more of a protective lens, a focusing lens, a spot curing lens, a diagnostic lens, and the like.

The light emitting systems and kits may include any light emitting device known in the art that includes at least one LED light source. In one embodiment, the light emitting device is sized and shaped so as to have the look and feel of a standard dental hand piece. The light emitting device may further have a size and shape so as to fit in a standard hand piece holder. An example of a light emitting device that has the look and feel of a standard dental hand piece is the ULTRA-LUME dental curing light, which is available from Ultradent Products, Inc., located in South Jordan, Utah. It will be appreciated, however, that the light emitting device can have any desired size or shape.

One type of removable lens that may be used with the light emitting systems and kits is a protective lens. Protective lenses within the scope of the invention may be flat or contoured to have a desired shape (e.g., conical). They may or may not focus or alter the quantity or color of light emitted by the light source. Conical lenses can be used, for example, to irradiate light curable compositions within Class II or deeper cavities. They may be used to optionally shape or press against compositions during a dental procedure.

A focusing lens may be used to collimate, diffuse or otherwise alter the shape or footprint of light emitted by the light source. Examples of focusing lenses include, but are not limited to, aspheric lenses, hemispheric lenses, ball lenses, other convex lenses, and concave lenses. Exemplary aspheric lenses are characterized as having a first end that is substantially flat and a second end that is curved in an aspheric manner (e.g., to have a hyperbolic or elliptical curvature). Exemplary hemispheric lenses are similar to aspheric lenses but have a hemispheric rather than an aspheric curvature. Ball lenses may be spherical, ellipsoidal or have any other desired curvature. Convex lenses are typically convexly curved on one or both sides, while concave lenses are typically concavely curved on one or both sides. In general, lenses with convex surfaces typically collimate light, while lenses with concave surfaces typically diffuse light.

A spot curing lens can be used to reduce the size of the footprint of light emitted by a light emitting device by blocking at least a portion of the light. Spot curing lenses may include an aperture through which light emitted by the light emitting device is allowed to pass and a portion surrounding the aperture that is completely opaque to light or that at least filters out a substantial portion of curing wavelengths. Spot curing lenses may be used, for example, to spot cure an adhesive resin through a transparent or translucent veneer, overlay, inlay, crown, or other restorative appliance to adhere the appliance to a substrate (e.g. a patient's tooth). The spot curing lens allows a dental practitioner to spot cure a portion of a light curable adhesive through the appliance, remove any excess uncured adhesive from around the perimeter of the appliance, and then light cure the remaining portion of the adhesive (e.g., after replacing the spot curing lens with another lens, or no lens, which allows the light emitting device to emit a larger footprint of light) in order to securely bond the appliance to the substrate. This eliminates the need for grinding, breaking, or scraping hardened excess adhesive from around the appliance.

A tissue illumination lens may be used in combination with an LED light source to enhance the visibility of oral tissues, such as teeth and soft oral tissues of the gums, tongue, lips, and cheeks. The tissue illumination lenses include one or more fluorescing dyes or pigments that are able to convert shorter wavelengths of light into longer wavelengths that are better able to penetrate tissues and illuminate defects therein. They may also include light absorbing dyes or pigments that are able to absorb certain wavelengths in order to reduce glare and enhance tissue illumination and visibility. The tissue illumination lenses can be used diagnostically to identify and locate diseased or defective oral tissues, e.g., caries, calculus, fractures, fissures, or other defects in teeth an/or diseased or abnormal soft oral tissues.

Kits according to the invention may include one or more light emitting devices and one or more lenses that may be interchanged as desired to yield a light emitting system having desired characteristics. Kits that include different types of lenses add versatility to otherwise simple light emitting devices.

These and other benefits, advantages and features of the present invention will become more fully apparent from the following description and appended claims, or may be learned by the practice of the invention as set forth hereinafter.

### BRIEF DESCRIPTION OF THE DRAWINGS

In order that the manner in which the above recited and other benefits, advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings, in which:

FIG. 1A is a perspective view of an exemplary light emitting device that includes an LED light source configured to emit radiant energy and a flat protective lens releasably attached to the light emitting device;

FIG. 1B is a top perspective view of the dental device of FIG. 1A that further illustrates controls that assist in controlling operation of the LED light source;

FIG. 1C shows the dental device of FIG. 1A received within a dental hand piece holding tray;

FIG. 2A illustrates an embodiment of a hollow cone-shaped protective lens that is releasably attached to a light emitting end of a light emitting device;

FIG. 2B illustrates an embodiment of a cone-shaped lens that is releasably attached to a focusing lens that it also releasably attached to a light emitting end of a light emitting device;

FIG. 2C illustrates a cone-shaped lens being inserted within a dental preparation;

FIG. 3A illustrates an exploded view of a light emitting end of a light emitting device to which a collimating lens is releasably attached to the light emitting device by means of a cone-shaped protective lens;

FIG. 3B is a partial cross-sectional view of an embodiment of an aspheric lens that is releasably attached to a light emitting end of a light emitting device by means of a cone-shaped protective lens;

FIG. 3C is a partial cross-sectional view of an embodiment of a hemispheric lens that is releasably attached to a light emitting end of a light emitting device by means of a cone-shaped protective lens;

FIG. 3D is a partial cross-sectional view of an embodiment of an aspheric lens that is releasably attached to a light emitting end of a light emitting device, and a cone-shaped protective lens releasably attached over the aspheric lens;

FIG. 3E illustrates an embodiment of a cone-shaped lens being inserted within the dental cavity preparation of a tooth, and in which light is being directed onto a light-curable composition within the dental cavity preparation.

FIG. 4A is a perspective view of the light source of a light emitting device comprising a pair of angled LEDs and a lens releasably attached to the light emitting

FIG. 4B is a cross-sectional side view of a dual LED light source and a t collimating lens releasably attached thereto that includes two hemispheric lenses concentrically aligned with the LEDs;

FIG. 4C is a cross-sectional side view of a dual LED light source and a collimating lens releasably attached thereto that includes two aspheric lenses concentrically misaligned with the LEDs;

FIG. 4D illustrates an exemplary path of illumination having a desired elliptical footprint as a result of light passing through a collimating lens;

FIGS. 5A-5D illustrate exemplary embodiments of spot curing lenses according to the invention that are releasably attached to a light emitting device or to another lens attached to the light emitting device;

FIG. 5E depicts an alternative embodiment of a spot curing lens releasably attached to a collimating lens that is itself releasably attached to the light emitting end of a light emitting device;

FIGS. 5F-5I illustrate several exemplary fittings for releasably attaching a spot curing lens according to the invention to a focusing lens attached to a light emitting device;

FIG. 6A depicts an exemplary tissue illumination lens that is configured to collimate light emitted by a single LED and that is releasably attached to the light emitting end of a light emitting device;

FIG. 6B depicts an exemplary tissue illumination lens that is configured to collimate light emitted by a pair of LEDs and that is releasably attached to the light emitting end of a light emitting device;

FIG. 6C depicts an exemplary tissue illumination lens that is cone-shaped and that is releasably attached to the light emitting end of a light emitting device;

FIG. 6D depicts an exemplary tissue illumination lens that is releasably connected to the light emitting end of a light emitting device, and an intermediate focusing lens disposed between the light source and the tissue illumination lens; and

FIG. 6E illustrates another exemplary tissue illumination lens.

### DETAILED DESCRIPTION OF THE PREFERRED EMBODIMENTS

I. Introduction and Definitions

The present invention encompasses light emitting systems and kits that include a light emitting device and at least one lens that can be releasably attached to the light emitting device. A detailed description of the light emitting systems and kits according to the invention will now be provided with specific reference to figures illustrating preferred embodiments of the invention. It will be appreciated that like structures will be provided with like reference designations. To provide context for interpreting the scope of the invention, certain terms used throughout the application will now be defined.

The term “LED light source” or “light source” includes any light emitting diode (LED) or LED array. The terms “LED” and “LED array” include the electrical components of the LED as well as the integral lens or micro lens of the typical LED structure. Accordingly, references made herein to embodiments of dental devices incorporating lenses are made with reference to secondary lenses or lenses that are not otherwise integrally included as part of the LED structure.

The term “lens”, as defined herein, refers to any object through which light may travel and does not inherently imply any characteristics for focusing or collimating light. Examples of “lenses” that may be used in connection with the light emitting systems and kits of the present invention include, but are not limited to, protective lenses (e.g., flat or contoured), focusing lenses (e.g., collimating or diffusing), spot-curing lenses, and tissue illumination lenses.

The term “dental hand piece,” as used herein, generally refers to a handheld dental device that engages rotary instruments for cutting, cleaning, polishing or otherwise treating teeth. The term “dental hand piece” is a term of art well known in the dental industry. Nonlimiting examples of dental hand pieces include high speed turbines, low speed turbines, ultrasonic devices, and 3-way syringes. Dental hand pieces are typically driven by pneumatic, electric, and ultrasonic mechanisms. They also have a standard size so as to fit within a standard dental hand piece holding tray.

The term “dental hand piece holding tray” generally refers to a tray configured with slots or holding devices specifically configured in shape and size for holding conventional dental hand pieces. Dental hand piece holding trays, which are well-known to those skilled in the art, are placed proximate or mounted directly to dental chairs for facilitating access to dental hand pieces held by the holding trays.

The term “footprint,” as used herein, is generally made with reference to the cross-sectional shape of the path of illumination of light emitted from a light source. The dimensions of the footprint will typically vary according to the distance of the footprint from the light source and the angle at which the light is emitted by the light source. The general shape and dimensions of a footprint can generally be identified by placing a flat object in front of a light source and observing the area illuminated by the light source.

The term “focusing,” as used herein, is generally used in reference to lenses for (collimating or diffusing light. The term “collimating” is defined as redirecting light emitted from a light source into a path of illumination having an angle of dispersion that is less than the angle in which the light is originally emitted from the light source, but which does not focus the light to a discrete focal point. The term “diffusing” is defined as redirecting light emitted from a light source into a path of illumination having an angle of dispersion that is greater than the angle in which the light is originally emitted from the light source.

The term “Class II,” as used herein, is made in reference to Class II Mesio-Occlusal caries and preparations that extend deep into the dental tissue. Class II preparations are typically at least 5 mm deep.

The term “aspheric” is generally defined herein to include any curvature departing from a spherical form. In particular, the term “aspheric” refers to any parabolic, hyperbolic, or ellipsoidal curvature.

The term “spot cure” refers to a procedure of curing less than the total area of a light curable composition (e.g., through a veneer or translucent dental appliance) without curing excess light curable composition that may be squeezed out around the perimeter of the appliance.

The term “spectrum of light” refers to light that is monochromatic or substantially monochromatic, as well as light that falls within a range of wavelengths. The term “wavelength”, when used in the context of the term “spectrum of light”, refers to either the actual wavelength of monochromatic light or the dominant wavelength within a range of wavelengths.

The term “light emitting system” refers to the combination of a light emitting j device and at least one lens releasably attached to the light emitting device.

The term “light emitting kit” refers to at least one light emitting device and at least one lens that is configured to be releasably attachable to the light emitting device without regard to whether or not the lens is actually attached to a light emitting device.

II. Light Emitting Systems and Kits

Light emitting systems according to the invention include at least one light emitting device, such as a dental curing light, having a light source and at least one lens that is releasably attached to the light emitting device in a manner so that at least a portion of the light emitted by the light source passes through the at least one lens. Light emitting kits according to the invention include at least one light emitting device, such as a dental curing light, having a light source and one or more lenses that are releasably attachable (i.e., that are not necessarily attached to the light emitting device). Light emitting kits according to the invention may include a variety of different types of lenses that can be interchanged to provide a multiplicity of functions. In this way, the releasably attachable lenses add versatility to an otherwise simple light emitting device.

Examples of light emitting devices and lenses that may be used within the scope of the invention are disclosed in the priority patent applications set forth above, which are incorporated by reference.

A. Light Emitting Devices Having an LED Light Source

Examples of light emitting devices that may be used in connection with the light emitting systems and kits according to the invention are disclosed in U.S. Pat. No. 6,331,111 to Cao; U.S. application Ser. No. 10/024,110, filed Dec. 17, 2001, and entitled “Heat Sink With Geometric Arrangement of LED Surfaces”; U.S. application Ser. No. 10/080,489, filed Feb. 22, 2002, and entitled “Light-Curing Device With Detachably Interconnecting Light Applicator”; U.S. application Ser. No. 10/324,596, filed Dec. 18, 2002, and entitled “Light Curing Device With Detachable Power Supply”; U.S. application Ser. No. 10/325,206, filed Dec. 18, 2002, and entitled “Cooling System For Hand-Held Curing Light”; and U.S. application Ser. No. 10/301,158, filed Nov. 21, 2002, and entitled “Wide Bandwidth LED Curing Light”. For purposes of disclosing light emitting devices that include one or more LEDs, the foregoing patent and applications are incorporated by reference.

In a preferred embodiment, the light emitting device will include at least one LED or LED array comprising at least a portion of the light source. One presently preferred light emitting device is embodied by the ULTRA-LUME dental curing light of Ultradent Products, Inc., located in South Jordan, Utah.

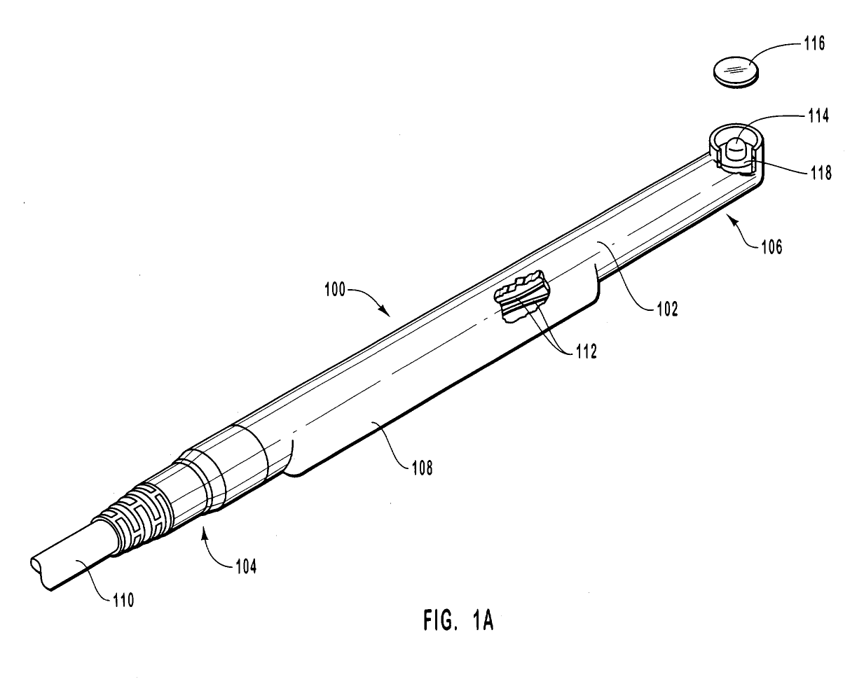

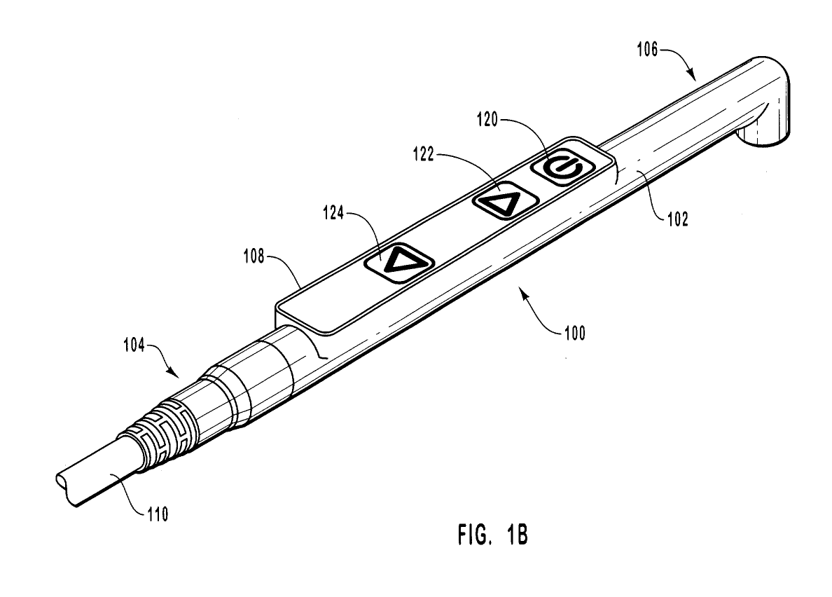

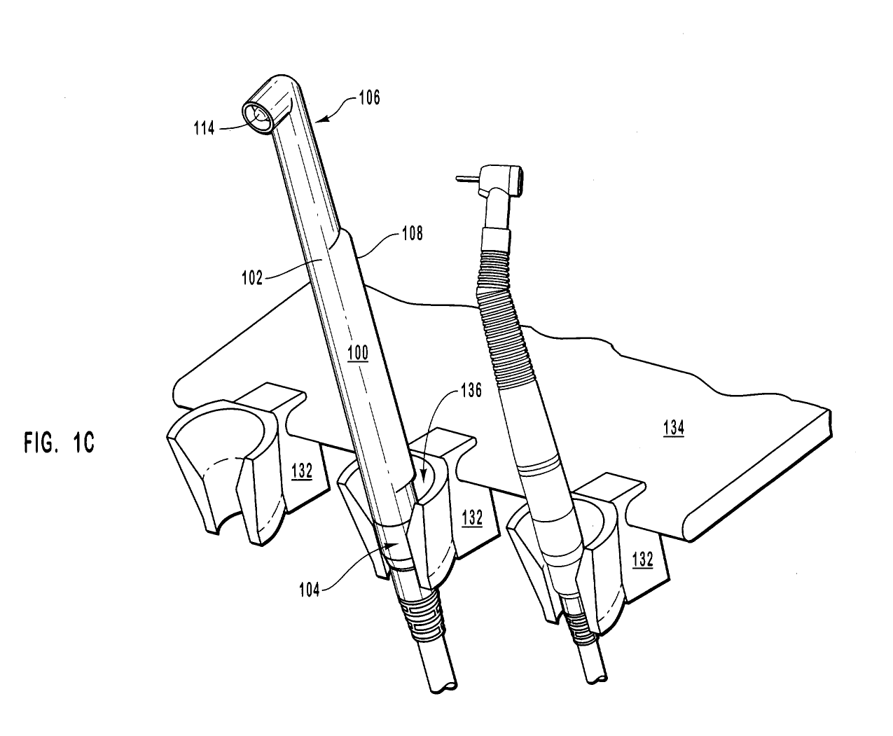

Reference is now made to FIG. 1A, which illustrates an exemplary light emitting device 100 including an LED light source. As shown, the light emitting device 100 has the general configuration of a dental hand piece with a sleek and slender body 102 that extends from a proximal end 104 to a distal end 106. The shape of the body 102 is generally cylindrical, being defined by a circular cross-sectional shape. It will be appreciated, however, that the cross-sectional shape of the body 102 may comprise other shapes, including, but not limited to, square, triangular, hexagonal, oval, and rectilinear cross sections. The body 102 may also include small or slight irregularities or protrusions such as protrusion 108, which is configured with control buttons for controlling the operation of the light emitting device 100. The sleek and slender body 102 of the light emitting device is also useful for enabling a dental practitioner to easily rotate and move the light emitting device 100 into various positions during a dental procedure.

The proximal end 104 of the light emitting device 100 is configured in size and shape to be inserted into the holding slot of a dental hand piece holding tray. As shown, the dental device 100 is also configured to be connected with a power cord 110 at the proximal end 104 of the body 102. Although not shown, the power cord 110 operably connects the light emitting device 100 with a power supply remotely located away from the dental device 100. The remote power supply may include an electrical wall receptacle, a battery pack, a generator, a transformer, or any other power supply suitably configured for providing an appropriate supply of power to the light emitting device 100 for illuminating a light source 114 of the light emitting device 100, which is disposed at the distal end 106 of the light emitting device 100.

The light source 114 advantageously comprises an LED configured to emit radiant energy that is suitable for curing light curable compositions. It will be appreciated, however that the light source 114 may also include an LED array, a plurality of LEDs, and other similar light sources. Although a variety of lenses that may be used in combination with light emitting devices will be discussed more fully below, FIG. 1A illustrates that a flat protective lens 116 that is releasably attached to the distal end 106 so as to cover the light source 114.

The light emitting device 100 further includes a heat sink 118 for dissipating heat generated by the light source 114 during use. As shown in FIG. 1A, the light source 114 is preferably mounted directly onto the heat sink 118 for enhancing the heat dissipating properties of the heat sink 118 through conduction. The heat sink 118 may comprise any heat conductive material, such as metal, examples of which include aluminum, copper, brass, steel, silver, and combinations of the foregoing.

According to one embodiment, the light emitting device 100 also includes controls for controlling the emission of radiant energy from the light source 114. The controls are advantageously mounted on the body 102 of the light emitting device 100 for ease of use. By way of example, not limitation, and as shown in FIG. 1B, the controls may include three different buttons 120, 122, and 124. The first button 120, when depressed, may be configured so as to activate the light source 114 for a predetermined duration of time, such as for example 15 seconds. In this embodiment, the second and the third buttons 122, 124 may be configured to increase or decrease the predetermined duration of time by any desired increment of time, such as for example by 5 second increments. The controls communicate with the power supply wires 112 (FIG. 1A) as needed to complete the electrical circuit.

In the alternative, the first button 120 is simply comprised of an on/off switch that, when depressed, activates the light source 114 for an indefinite period of time until depressed again to turn the light source off. In this embodiment, the second and third buttons, 122, 124, may be configured to increase or decease the intensity of light that is emitted by the light source 114.

The light emitting device 100 may optionally be configured with sound effects. For example, when activation button 120 is depressed, the device 100 may emit a sound signaling to the user that the device has been activated or deactivated. When pressing button 122 to increase the predetermined duration of time or the intensity of light emitted by the light source 114, the device 100 may emit a sound increasing in pitch, signaling to the user that the control instruction was received. Similarly, when pressing button 124 to decrease the predetermined duration of time or the intensity of light that is emitted, the device may emit a sound decreasing in pitch. Other sound effects may be selected as desired to signal to the user that a particular function has been activated or carried out.

FIG. 1C illustrates how, according to one embodiment, a holder 132 can be used to hold the light emitting device 100 on a dental hand piece holding tray 134. As shown, the dental hand piece holding tray 134 includes several holders 32 with holding slots 36 formed therein for holding dental hand pieces.

B. Exemplary Lenses

A curing light kit or system may include a dental curing light device and a detachable lens. The detachable lens may be a cone-shaped lens, a collimating lens, a diffusing lens, a spot curing lens, or a diagnostic lens. Each type of lens will be discussed in detail below.

1. Protective Lenses

It is within the scope of the invention to utilize any removable lens that can be used to protect the LED light source. As shown in FIG. 1A, a flat protective lens 116 can be releasably attached to a light emitting device to protect an LED light source contained therein. In other embodiments, a protective lens may be shaped, such as with a conical shape, in order to provide alternative functionality. In some cases, a protective lens may be used in connection with other lenses, such as a focusing lens, as discussed more fully below.

During certain dental procedures, such as treatment of deep Class II fillings, it may be necessary for the light to be directed deep into the dental preparation and with sufficient intensity to cure a light-curable composition placed therein. To facilitate the dispersion of light within a Class II preparation, or any other deep preparation, it is sometimes desirable to use a cone-shaped tip or lens that can be inserted within the dental preparation, thereby enabling the radiated light to be dispersed within the desired treatment area.

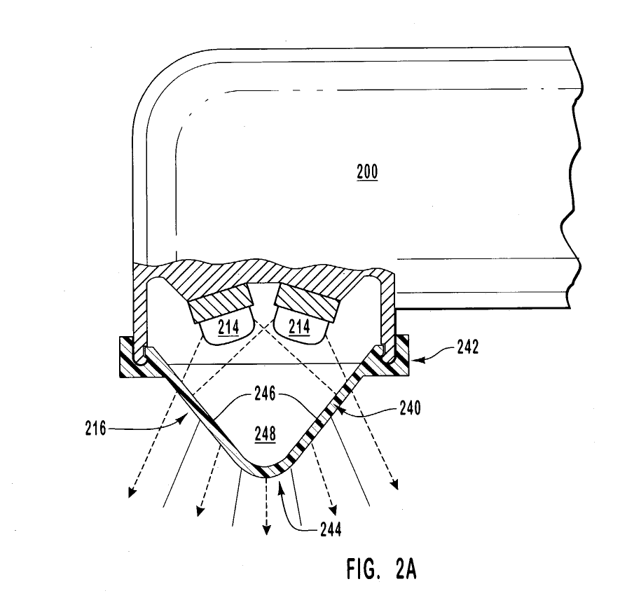

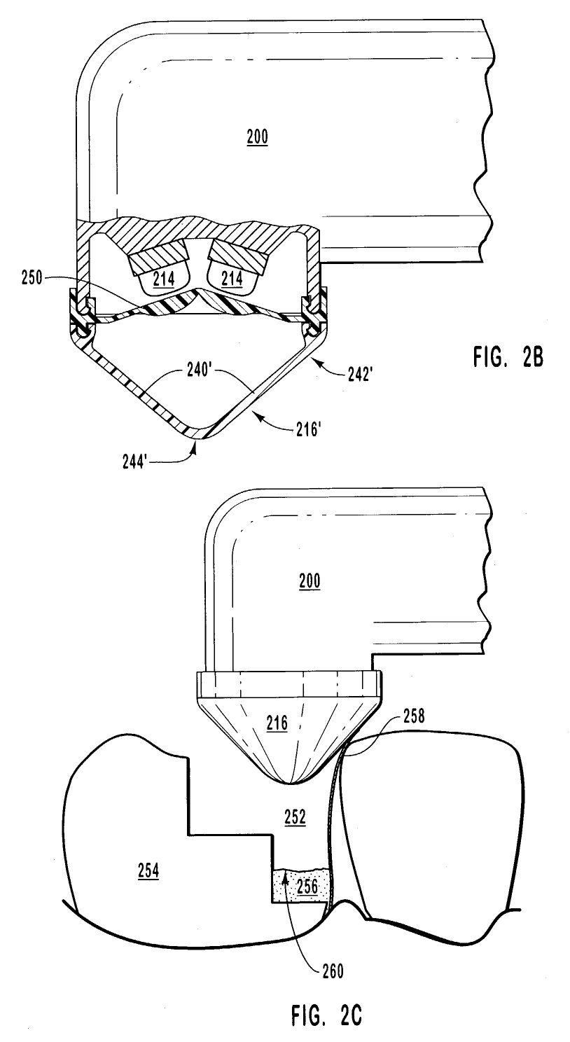

FIG. 2A illustrates an exemplary embodiment of a cone-shaped lens releasably attached to a light curing device 200 comprising LED light sources 214. As shown, the lens 216 includes a hollow body 240 having a substantially conical profile to enable the lens 216 to be inserted at least partially within a dental preparation, as mentioned above. The hollow body 240 extends from a base 242, which circumferentially extends around the body 240, to an apex 244. A wall 246 extends from the base 242 and converges at the apex 244, defining a conical void 248 therewithin.

In one embodiment, the wall 246 and the apex 244 can have a substantially uniform thickness, such that light passing through the lens 216 in a forward direction is able to pass through the apex 244 without being undesirably refracted by the lens 216. Nevertheless, it is certainly within the scope of the invention to provide a lens in which the thickness of the wall 246 and apex 244 differ such that one is thicker or thinner than the other. One benefit provided by the hollow cone-shaped lens 216 is that it enables light to pass through the lens 216, particularly through the front portions of the lens 216 in the region of the apex 244, without being refracted, such that the light is enabled to be emitted with a desired intensity directly in front of the apex 244. At least a portion of the lens 216 may be coated or impregnated with one or more fluorescing or light-absorbing dyes or pigments.

The thickness of the lens 216 in the wall 246 and apex 244 regions is preferably in a range of about 0.1 mm to about 2 mm, more preferably in a range of about 0.2 mm to about 1 mm, and most preferably in a range of about 0.25 mm to about 0.5 mm. For example, in one embodiment of a cone-shaped lens 216, the thickness of the lens 216 in the wall 246 and apex 244 regions is about 0.015″ (about 0.381 mm).

The base 242 of the lens 216 is preferably configured to engage and connect with the light emitting end of a light-curing device 200. In the present embodiment, the base 242 of the lens 210 is configured to detachably connect to the light-curing device 200 with a snap-fit connection, although other types of connections known in the art may be used. For instance, in other embodiments, the lens 216 may be configured to engage the light-curing device 200 with a friction fit, a press fit, a threaded coupling, a bayonet coupling, or any other type of coupling.

Lenses according to the invention may comprise any desired transparent or translucent material. According to one embodiment, the lenses may be manufactured out of any transparent or translucent material, including, but not limited to acrylic, m polyacrylic, polypropylene, polycarbonate, silicone, aluminum dioxide, sapphire, quartz, and glass.

Although protective lenses may not be specifically designed to focus light emitted from a light-curing device, other intermediary lenses used to focus light may be used in combination with a protective lens. An example of such an embodiment is illustrated in FIG. 2B. As shown, a cone-shaped lens 216′ in this embodiment is connected with the light-curing device 200 via an intermediary lens 250. The intermediary lens 250 is used to collimate the light that is emitted from the LEDs 114, as described in more detail in U.S. patent application Ser. No. 10/068,397, which is incorporated by reference.

In the present embodiment, the lens 216′ is configured to couple with the intermediary lens 250 with a snap-fit connection, such that the cone-shaped lens 216′ and the intermediary lens 250 may be detachably connected. It will be appreciated, however, that in other embodiments, the lens 216′ and the intermediary lens 250 may be integrally connected to form an integral collimating cone-shaped lens that is releasably connected to the light-curing device 200. As shown, the intermediary lens 250 is configured to couple with the light-curing device 200 with a snap fit type connection, although any connecting means known in the art may be used to connect the intermediary lens 250 to the light-curing device 200.

It will be appreciated that light that is collimated by the intermediary lens 250 is able to pass through the external lens 216′ in the region of the apex 244′ without being undesirably refracted. This is particularly useful when treating deep dental preparations, such as Class II dental preparations.

FIG. 2C illustrates one embodiment in which a lens 216 of the invention is positioned into a deep dental preparation 252 of a tooth 254. The dental preparation 252 may represent a Class II dental preparation or any other deep dental preparation. As shown, the lens 216 is configured with a cone-shaped body that enables the lens 216 to be inserted at least partially within the dental preparation 252. Inserting the lens 216 within the dental preparation 252 is useful for preventing the emitted light from being dispersed to other areas within the patient's mouth. The conical shape of the lens 216 can further be used to press against and manipulate uncured filling material 256 (e.g., a light curable composition).

As shown, the lens 216 is also disposed against a matrix band 258 that may be used for providing form when filling the dental preparation 252. Matrix bands are well known to those of skill in the art. During the dental filling procedure, a dental filling material 256 is placed within the dental preparation 252 and cured with a suitable light-curing device. If the dental preparation 252 is very deep, the filling procedure may occur in stages, so that initially deposited dental filling material 256 can be sufficiently cured before adding new material. For instance, the dental filling material 256 may be cured with light emitted from the light-curing device 200 before additional dental filling material is added to the dental preparation 252.

It will be appreciated that during certain dental filling procedures, it is necessary for the light-curing device to emit light directly in front of the apex of the lens 216 so that the dental filling material 256 can be sufficiently cured. In the illustrated embodiment, the dental filling material 256 is disposed at a location 260 that may not be irradiated sufficiently unless the light-curing device 200 is able to emit light directly in front of the apex of the lens 216.

A cone-shaped lens may also be used to manipulate the light-curable composition within the dental preparation 252. For instance, once the dental preparation 252 is sufficiently filled with the dental filling material 256, the lens 216 may be used as a compression tool to work and compress the dental filling material 256 to ensure that the dental filling material 256 is properly distributed within the dental preparation 252. To facilitate this functionality, the lens 216 may be configured with a blunt and rounded apex, as shown.

2. Focusing Lenses

It is within the scope of the invention to utilize various types of focusing lenses in order to alter the footprint of light emitted by a light emitting device. Examples of focusing lenses include both collimating lenses, which reduce the footprint of light emitted by a light emitting device, and diffusing lenses, which increase the footprint of light. Although diffusing or other focusing lenses are certainly within the scope of the invention, in the context of dental procedures, focusing lenses which have the most applicability are collimating lenses.

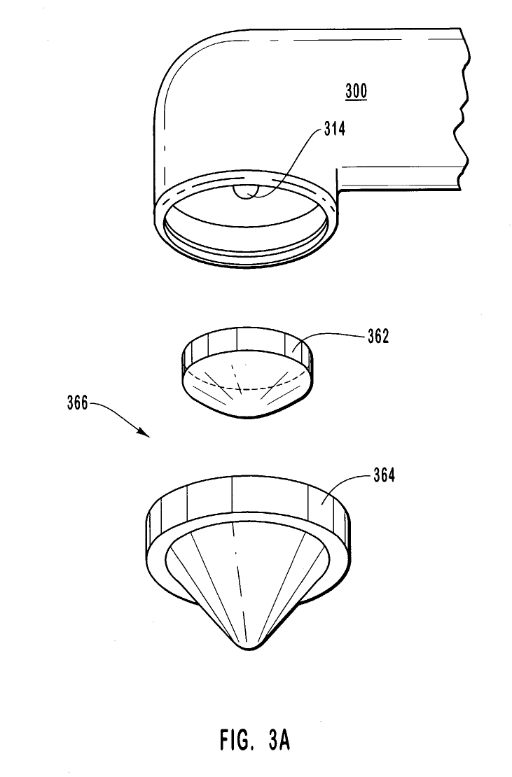

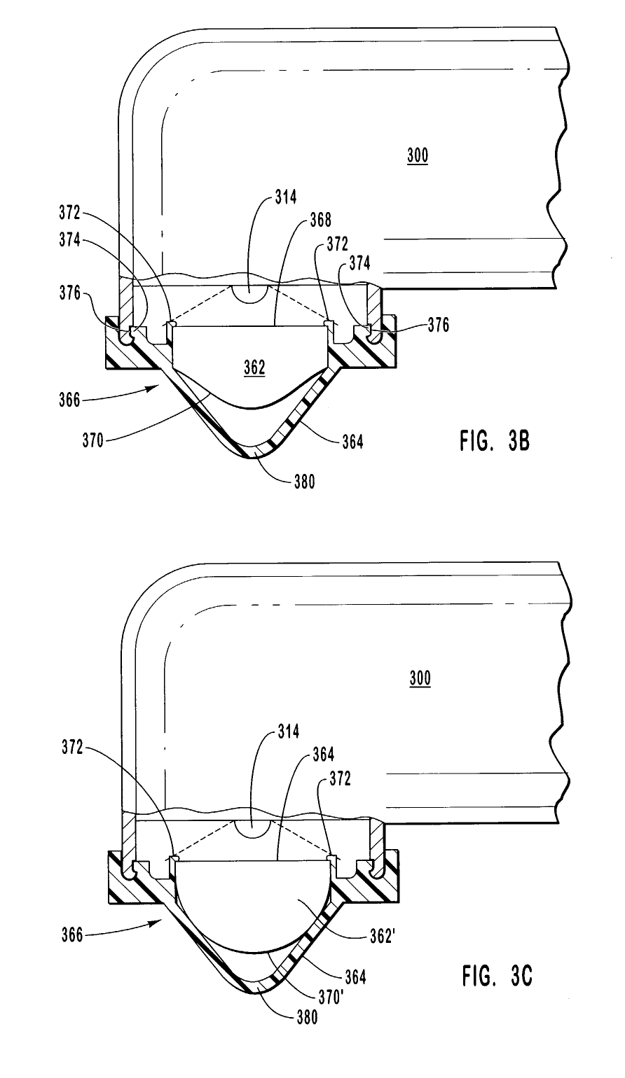

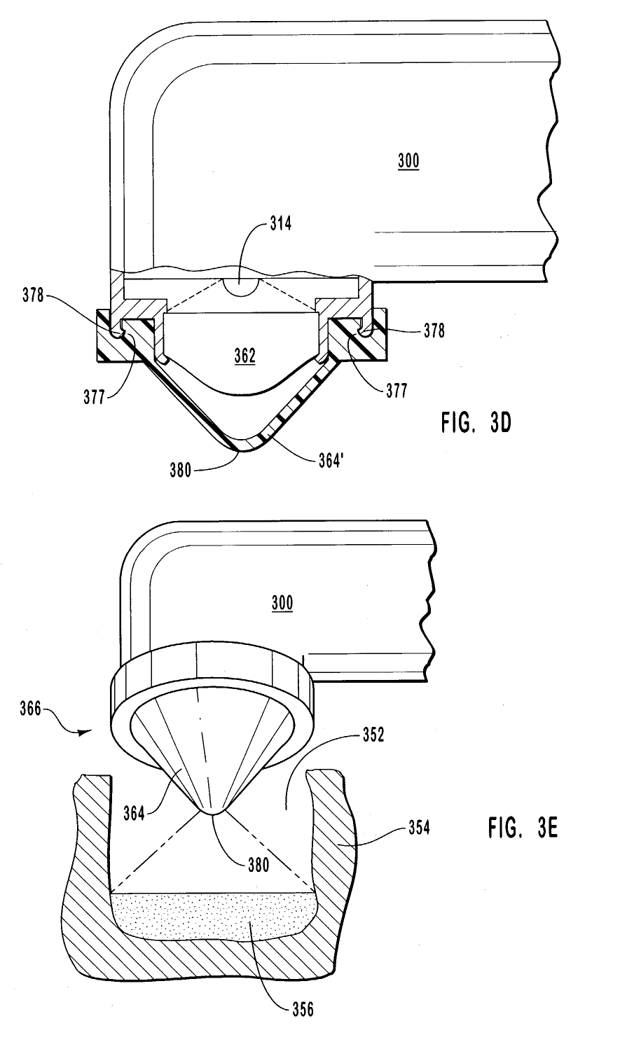

Reference is now made to FIG. 3A, which depicts a collimating lens 362 that may be used alone or in combination with a cone-shaped protective lens 364 to form an optical device 366 comprising the combination of a collimating lens and a cone-shaped lens. The collimating lens 362 focuses and collimates light emitted from an LED light source 314 of a light emitting device 300. According to one preferred embodiment, the collimating lens 362 comprises an aspheric lens, which may be releasably attached to the light emitting device 300 by the cone-shaped lens 264.

Referring now to FIG. 3B, it is shown how collimating lens 362 comprises a first end 368 which is substantially flat and a second end 370, which is defined by a curvature. The curvature of the second end 370 is preferably aspheric, e.g., comprising one of a hyperbolic curvature, a parabolic curvature, or an elliptical curvature. According to an alternative embodiment shown in FIG. 3C, the second end 370′ of the collimating lens 362′ may also comprise a hemisphere or hemispheric curvature. The function of the second end 370, 370′ of the collimating lens 362, 362′ is generally to focus and collimate light into a predetermined focus of illumination or footprint.

According to one embodiment, the optical device 366 also comprises means for securely holding the lens 362 in place so that the substantially flat first end 368 of the lens 362 is held in close proximity to, and facing, the LED 314, as shown in FIG. 3B. This generally causes light emitting from the LED 314 to enter the substantially flat first end 368 of the lens 362. According to one embodiment (not shown) the LED 314 is ground flat so that the lens 362 can be placed directly against the flat surface of the LED 314. This allows more of the light emitted from the LED 314 to enter the lens 362.

It will be appreciated that cone-shaped lens 364 comprises one suitable means for securely holding the collimating lens 362 in place. In particular, the cone-shaped lens 364 may hold the collimating lens 362 securely in place by frictionally engaging the side surfaces of the collimating lens 362 or alternatively the cone-shaped lens 364 may be configured with clips 372, as shown, which wrap around and secure the collimating lens 362 in place. The cone-shaped lens also effectively protects the collimating lens 362 during use.

The cone-shaped lens 364 may be configured to be releasably attachable to light emitting device 300. As a matter of illustration, and not limitation, the cone-shaped lens 364 may comprise ridges 374 that are configured for mating with corresponding grooves 376 in the light emitting device 300, as shown in FIG. 3B. According to another example, as shown in FIG. 3D, the cone-shaped lens 364′ may also comprise grooves 377 that mate with corresponding ridges 378 of the light emitting device 300. According to yet another embodiment, cone-shaped lens 364′ may be releasably attachable to light emitting device 300 with a friction fit (not shown) or with threads (not shown) for screwing the cone-shaped lens 364′ onto corresponding threads (not shown) of the light emitting device 300.

According to one preferred embodiment of the collimating lens 362, light exiting from the optical device 366 is focused by the collimating lens 362 into a desired focus of illumination that is suitable for performing Class II restorations. According to one preferred embodiment, the desired focus of illumination, or footprint cast by the light, comprises a diameter of about 8 mm at a distance of about 3 mm to about 5 mm away from the apex 380 of the cone-shaped lens 364. Because the spacing between the collimating lens 362 and the apex 380 of the cone-shaped lens 364, 364′ may vary according to different embodiments, the distance between the collimating lens 362 and the desired focus of illumination may also vary accordingly.

Turning now to FIG. 3E, it is shown how optical device 366 is configured for being inserted into the dental cavity preparation 352 of a tooth 354. Dental cavity preparation 352 may, as shown, be filled with a light-curable composition 356 that is cured when light radiation activates photosensitive components within the light-curable compositions, thereby enabling the light-curable compositions to polymerize and harden within the dental cavity preparation.

During use, the apex 380 of the optical device 366 is inserted into the dental cavity preparation 352, and light is emitted for curing the light-curable composition 356. As described above, the light may be focused by the optical device 366 into a focus of illumination having a diameter, for example, of about 8 mm at a distance of about 3 mm to about 5 mm from the apex 380, which is desirable for curing Class II dental restorations. It will be appreciated, however, that the collimating lenses and cone-shaped lenses may be configured to create a focus of illumination of any dimension, suitable for curing any type of dental restoration.

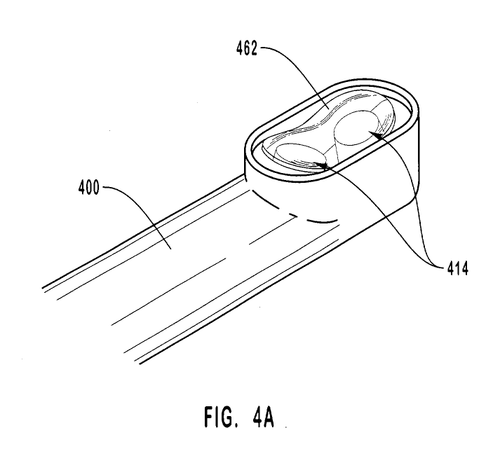

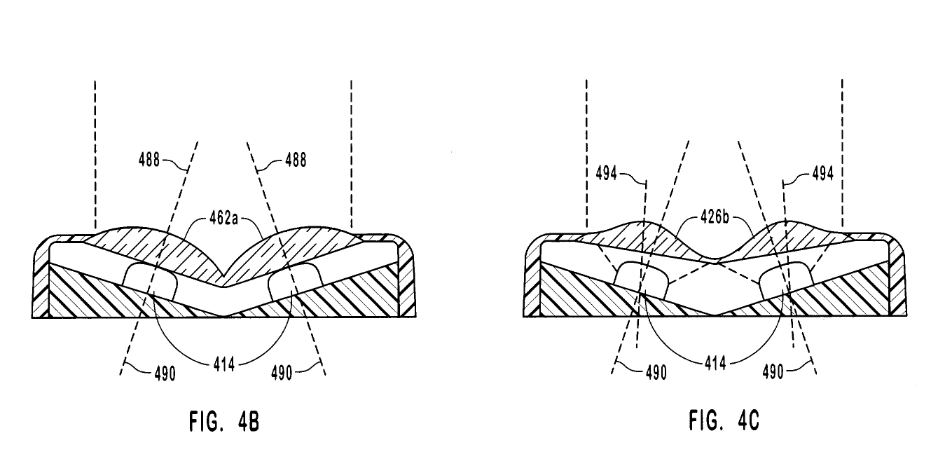

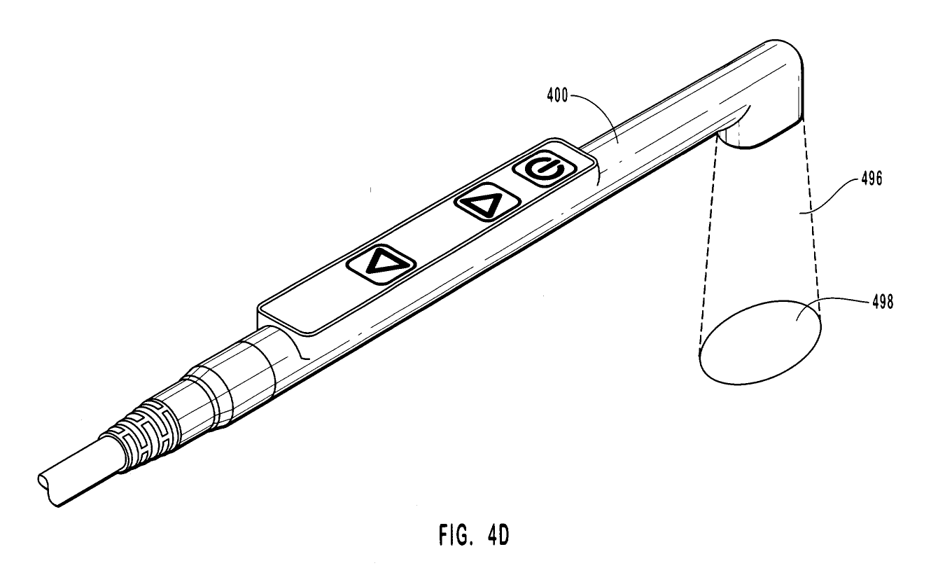

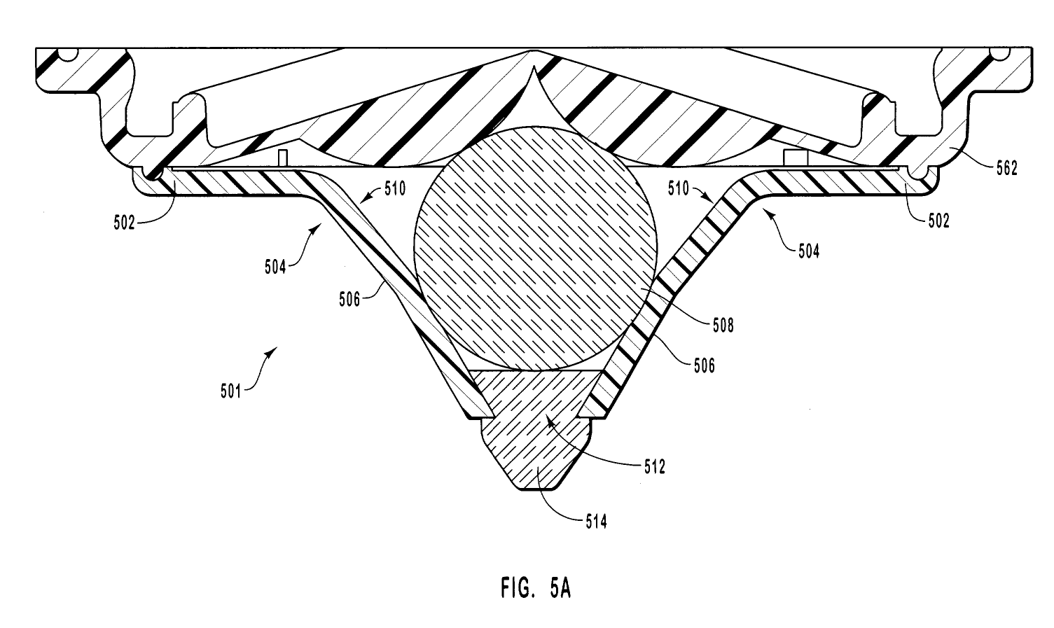

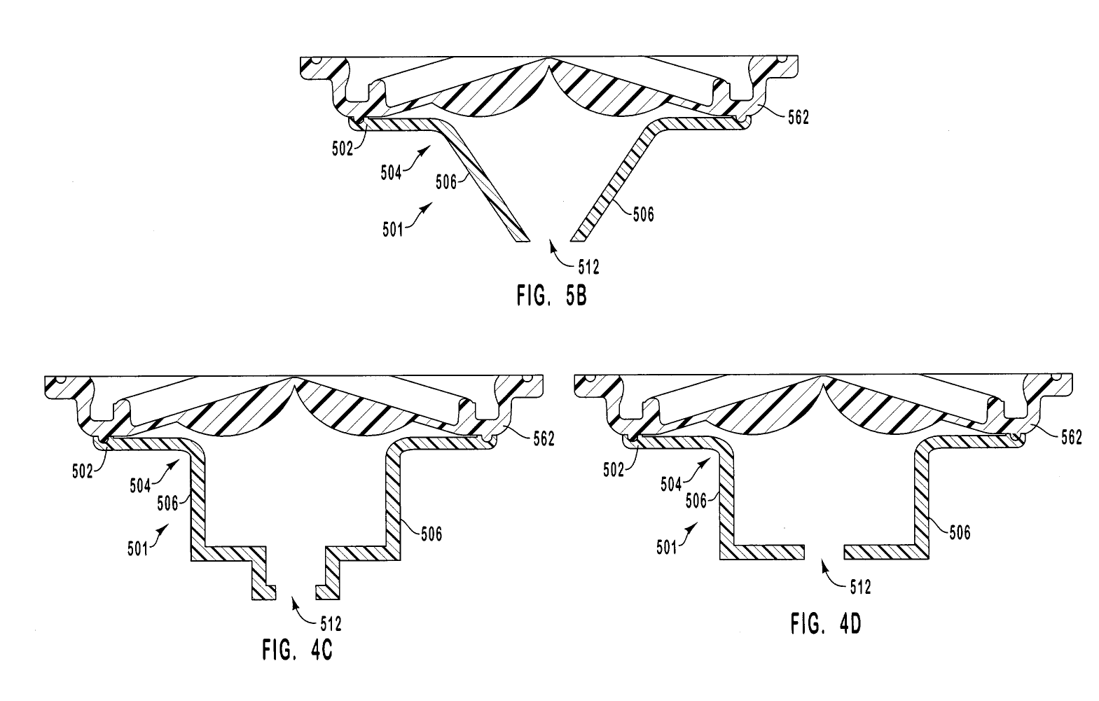

The collimating lens may also be used without a cone-shaped lens. In addition, the collimating lens may be configured to fit over two or more LEDs. Reference is now made to FIG. 4A, which illustrates an alternative collimating lens 462 in place over an LED light source 414 of a light emitting device 400 that includes 2 LEDs. According to this embodiment, the lens 462 comprises a single integral collimating lens configured to cover both of the LEDs 414. In embodiments that include more than two LEDs, the lens 462 may be correspondingly configured to cover the additional LEDs. The shape and curvature of the lens 462 may also be customized to create a desired optical effect.

Collimating the light emitted from the LEDs 414 can also be accomplished with various collimating lens designs. For instance, as shown in FIG. 4B, the focusing means includes two independent hemispherical collimating lenses 462a that are concentrically aligned with the LEDs 414. In other words, the central axis 488 of each hemispherical collimating lens 462a is aligned with the central axis 490 of a corresponding LED 414. This causes the light emitted by the LEDs 414 to be refracted into a path of illumination having a desired footprint, as described below in more detail in reference to FIG. 4D.

Generally, the desired optical effect of the collimating lens is to reduce the angle of dispersion of about 120° to about 140° in which light is typically emitted from an LED. By reducing the angle of dispersion, it is possible to collimate the light so that the light emitting device 400 can efficiently operate within a greater range of distances from the desired application site. By way of example and not limitation, collimating the light enables the light emitting device 400 to irradiate a desired application site with substantially the same intensity of radiant energy at about 8 mm as at a distance of about 5 mm.

FIG. 4C illustrates another embodiment of a collimating lens. As shown, the collimating lens comprises two aspheric collimating lenses 462b disposed above and concentrically misaligned with the two LEDs 414. In other words, the central axis 494 of each aspheric collimating lens 462b is askew to the central axis 490 of the LED 414 to which it corresponds. It has been found that by offsetting the respective axes 494, 490 of the aspheric collimating lenses 462b and the LEDs 414, it is possible to create a desired collimating effect of the light emitted from the LEDs 414.

FIG. 4D is a top perspective view of a light emitting device 400 emitting light within a path of illumination 496. The light emitted from the light emitting device 400 is substantially collimated by a collimating lens of the device 400, as generally described above but not shown in FIG. 4D. According to this embodiment, the path of illumination 496 comprises a substantially elliptical footprint 498. The elliptical shape of the footprint 498 is useful because it corresponds with the shape of dental surfaces, which are commonly substantially elliptical, where the light is directed during dental restoration procedures, thereby increasing the overall efficiency of the light emitting device 400. It will be appreciated, however, that the footprint of light may also comprise other shapes, such as, for example, shapes generated by light sources that include a single LED or three or more LEDs.

According to one embodiment, the dimensions of the elliptical footprint 498 fall within the range of about 8 mm to about 14 mm in width and within the range of about 10 mm and 16 mm in length at distances of between about 5 mm and about 8 mm from the light source. According to one preferred embodiment, the elliptical footprint 498 is dimensioned about 10 mm in width and about 12 mm in length at distances between about 5 mm and about 8 mm away from the light source of the light emitting device 400.

It will be appreciated that although specific examples have been provided above, regarding specific shapes and curvatures of the collimating lens, the collimating lens may comprise any desired shape for focusing and collimating light into a desired footprint.

3. Spot Curing Lenses

Spot curing lens of the present invention typically include a base configured to attach to a light emitting device, a lens body having a proximal first end through which light energy from the light emitting device enters, and a second end or aperture distal to said base that is smaller than the first end through which light energy exits. The spot curing lens also includes a wall extending between the first and second ends of the lens body that at least partially inhibits transmission of curing light energy therethrough.

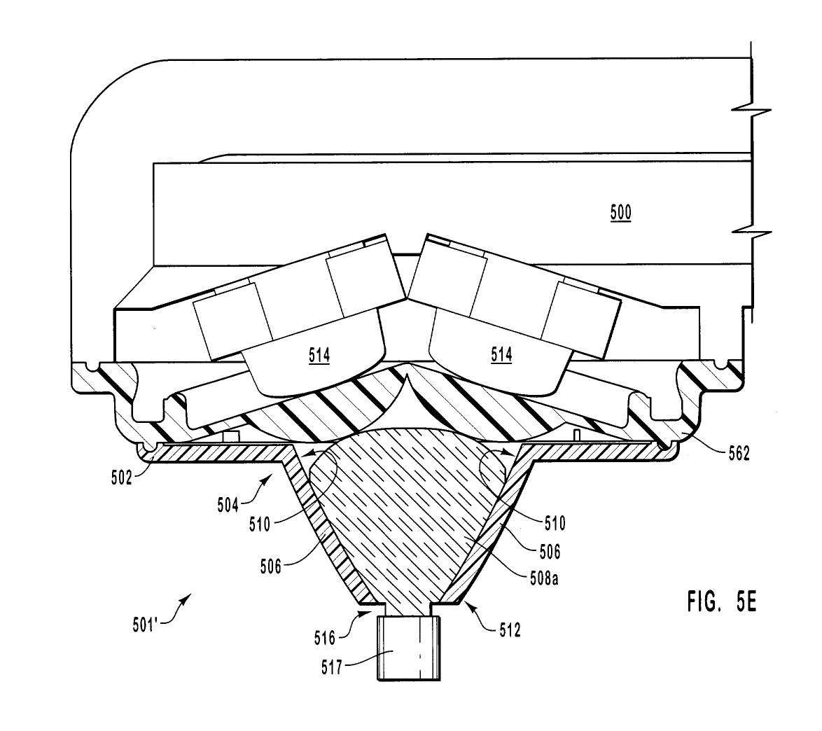

FIG. 5A illustrates an exemplary embodiment of a spot curing lens 501 according to the present invention. Spot curing lens 501 includes a base 502, a lens body 504, a wall 506, and a spherical focusing lens 508 disposed within a hollow interior defined by lens body 504. The base 502 is configured to releasably attach the lens 501 to a light emitting device. In the embodiment shown in FIG. 5A, the spot curing lens 501 is actually attached to an intermediate focusing lens 562 that is itself attached (integrally or releasably) to a light emitting device (not shown). It will be understood that the intermediate lens 562 is optional such that the spot curing lens 501 can be attached directly to the light emitting device (not shown) by any desired attachment means known in the art. For example, the spot curing lens 501 may be attachable to a light emitting device by means of a snap fit, a press fit, a friction fit, a threaded coupling, a bayonet coupling, or any other type of coupling. Alternatively, the base 502 may be integrally attached to the light emitting device or intermediate lens 562.

The lens body 504 of the spot curing lens 501 includes a first end 510 and a second end 512, the first end 510 being proximal to the base 502, and the second end 512 being distal to the base 502. The second end 512 is smaller than the first end 510. Light energy emitted by a light emitting device enters the body 504 through the first end 510 and exits through the second end 512.

A wall 506 extends between first end 510 and second end 512. Wall 506 at least partially inhibits transmission of curing light energy through the wall 506 so that curing light energy transmitted by the spot curing lens 501 has a pattern or footprint that is smaller than the footprint of light energy that enters first end 510. Reducing the pattern of curing light energy allows a user of a light curing device to selectively cure a portion of a light curable composition through a dental appliance (e.g., a veneer) without curing any excess adhesive that may extend beyond the perimeter of the appliance. Although a conical lens body 504 is preferred, any lens body tapered from the first end 510 to the second end 512, or even a cylindrical lens body (as seen in FIGS. 5C and 5D) could be used. All that is required is that the lens body 504 allow a user of the spot curing lens 501 to cure a portion of a light curable composition without curing any excess composition extending beyond the perimeter of the dental appliance as might occur when using a light emitting device without a spot curing lens.

In order to limit or reduce the pattern of curing light output through the spot curing lens 501, the wall 506 is at least partially opaque to curing wavelengths. The wall 506 may be completely opaque to all wavelengths or simply opaque to the component of emitted light energy comprising curing wavelengths. The latter embodiment may be accomplished by tinting the wall 506 (e.g., with UV orange) to selectively absorb and prevent curing wavelengths (e.g., blue, violet or UV) from D passing through the wall 506. Because of the opacity of the wall to curing light energy, curing light energy from the light emitting device passing through the spot curing lens 501 is emitted only through the relatively narrow second end 512. This allows a dental practitioner to selectively spot cure a portion of a light curable composition through a transparent or translucent dental appliance.

The second end 512 may be an empty void opening to lens body 504 (FIGS. 5B-5D), or it may optionally be at least partially filled by a transparent or translucent tip 514 (FIG. 5A). If a tip is present, the tip 514 is adjacent to or within second end 512. Tip 514 is transparent or translucent to curing light energy, which allows it to pass through tip 514. The tip 514 may be desirable to keep foreign matter or objects from entering the lens body 504 and contaminating the spot curing lens 500. Tip 514 may be flexible or hard, as desired. It may be formed, for example, of urethane, silicone, polyethylene, or any other elastomer with suitable transmission characteristics with respect to curing light energy. Using a soft tip allows the dental practitioner to hold the dental appliance in place with the tip while reducing the risk of breaking or cracking the veneer or other appliance as the dental practitioner presses the tip 514 against the appliance.

Spot curing lens 501 may also include one or more focusing lenses, such as focusing lens. The curing device shown in FIG. 5A includes an intermediate lens 562 for focusing light before entering the spot curing lens 501. Focusing lens 562 collimates the light that is emitted from the light emitting device (not shown). Exemplary focusing lenses for use in focusing light energy emitted by a plurality of LEDs are described in detail in U.S. application Ser. No. 10/044,346, which is incorporated by reference. After passing through lens 562, the light enters a spherical focusing lens 508 and is further collimated before exiting out of the spot curing lens 500 through second end 512. Lenses 508 and 562 are optional, and the space they occupy in FIG. 5A could alternately be empty, allowing the curing light energy to simply enter spot curing lens 500 through first end 510 and exit through second end 512. Focusing lenses 508, 562 as described or other lenses may be formed of any transparent material known and used in the art as described herein.

FIG. 5E illustrates an alternative embodiment of a spot curing lens 501′ attached to a light emitting device 500. Spot curing lens 501′ includes a base 502, a lens body 504, a wall 506, and an optional focusing lens 508a. Focusing lens 508a is of a different design than spherical focusing lens 508 of FIG. 5A. Focusing lens 508a includes a curved surface adjacent to the first end 510 of lens body 504 through which light energy enters and a light emitting tip 516 adjacent to second end 512 of the lens body 504. The focusing lens 508a also includes a cylindrical extension 517. Also illustrated in FIG. 5E is an array of two LED light sources 514.

Spot curing lenses according to the invention may be attachable and detachable from the distal end of a light emitting device using any known attachment means, such as with a snap fit, a friction fit, a press fit, a threaded coupling, a bayonet coupling, or any other type of coupling for enabling the spot curing lens or different types of lenses with different functionality to be interchangeably used with a light emitting device according to need and preference.

5. Tissue Illumination Lenses

A fluorescing lens can be used to convert light emitted by a light emitting device into light having a longer wavelength. In the case of violet or blue light emitted by some LEDs, shifting the light to a longer wavelength (e.g., green, yellow, orange or red) increases the ability of the light to illuminate, and make visible more defects in at least one type of oral tissue. For example, the tissue illuminating lens may be useful in visually identifying one or more of caries, calculus, fractures, fissures or other defects in teeth and/or diseased or abnormal soft oral tissues. Exemplary tissue illumination lenses are disclosed in U.S. application Ser. No. ______, which is incorporated by reference.

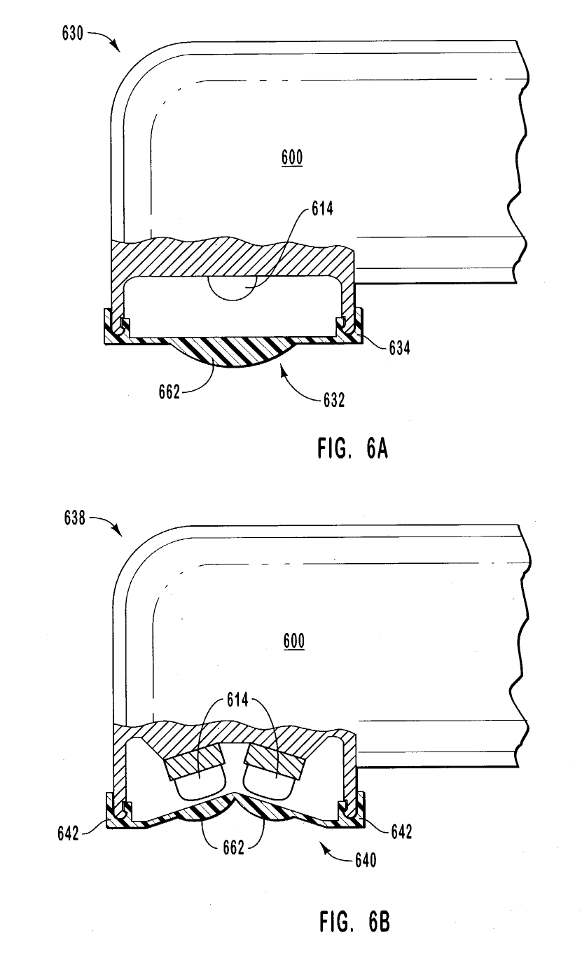

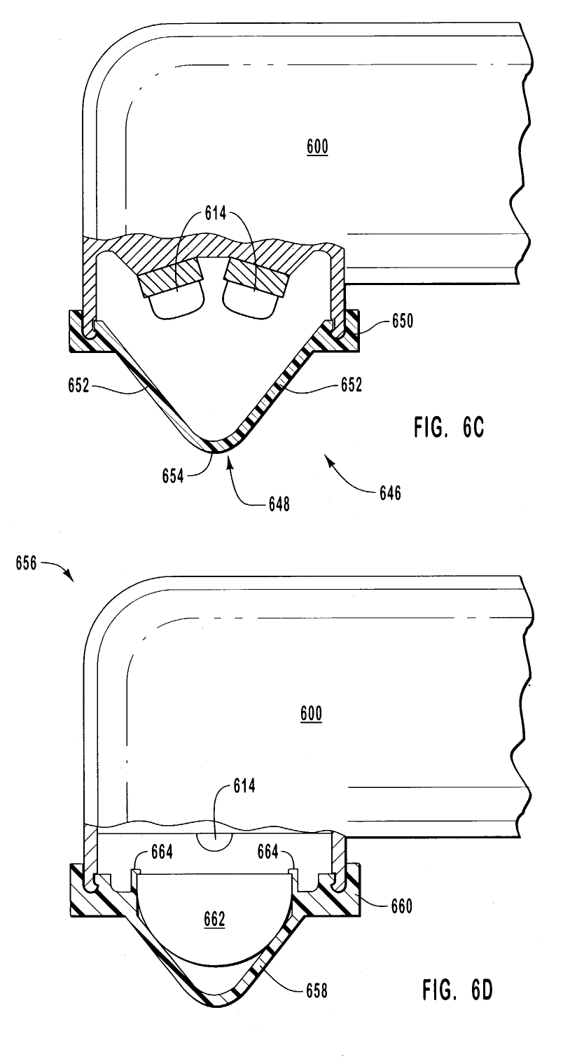

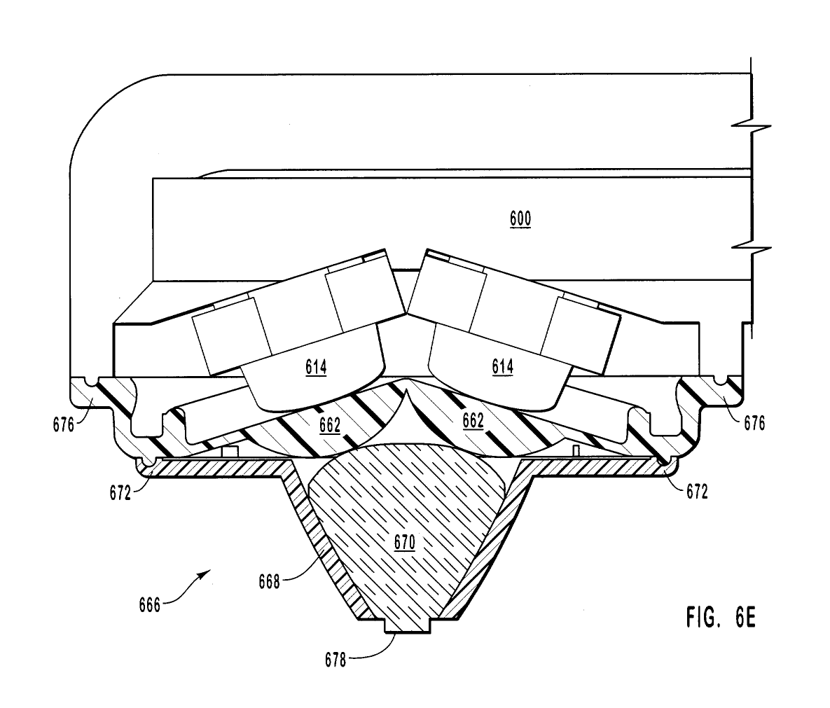

FIG. 6A illustrates an exemplary tissue illumination apparatus 630 according to the present invention which includes a light emitting device 600 and a fluorescing lens 632 attached to the light emitting device 600. The light emitting device 600 includes a light source 614, such as an LED, which is adapted to emit a predetermined spectrum of light. In one embodiment, the spectrum of light emitted by the light source 614 includes violet and blue light (approximately 375-525 nm, e.g., 410-490 nm) in order for the spectrum of light to be suitable for curing one or more different types of light-curable dental compositions. In this embodiment, the light emitting device 600 would be suitable as a dental curing light. It will be appreciated, however, that the spectrum of light emitted by the light source 614 may include light composed of any desired color or group of colors. The spectrum of light emitted by the light source 614 may be monochromatic or within a range of wavelengths.

The exemplary diagnostic lens 632 includes one or more attachment structures 634 that aid in releasably attaching the lens 632 to the light emitting device 600. The attachment structure 634 shown in FIG. 6A is a snap fit structure that is configured to mate with corresponding structure located on the light emitting device 600. It will be appreciated, however, that the attachment structure 634 can be modified to provide any desired mode of attachment to the light emitting device 600 (e.g., a compression fit, a friction fit, a press fit, a threaded coupling, a bayonet coupling, adhesive, tape, and the like).

The lens 632 also includes a focusing lens or portion 662 that is able to focus light emitted by the light source 614. At least a portion of the light emitted by the light source 614 is captured by and passes through the focusing lens or portion 662. Some of the light may also pass through the remaining portion of the lens 632 depending on the angle at which light is emitted by the light source 614. It will be appreciated that the lens 632 can be altered so as to not include a focusing portion or lens 662 (e.g. lens 632 could be flat on both surfaces), or so as to have multiple focusing lenses as desired.

Because of the orientation of the lens 632 relative to the light source 614, light energy emitted by the light emitting device 600 enters a side of the lens 632 proximal to the light source 614 and exits through the distal side. In this way, the lens 632 is able to transmit at least a portion of the light emitted by the light source 614.

At least a portion of the tissue illumination lens 632 comprises at least one fluorescing dye, pigment or other compound that is able (or adapted) to convert at least a portion of the spectrum of light emitted by the light source 614 to an altered spectrum of light having a longer wavelength. The lens 632 may be impregnated, coated or it otherwise made using one or more fluorescing compounds. Two or more different fluorescing compounds can be used, e.g., mixed together or layered within or on the lens 632 to get a blended effect or within different sections of the lens to yield different sections of transmitted light having different wavelengths.

In one embodiment, the lens 632 comprises a first layer comprising a first fluorescing compound that converts at least a portion of the spectrum of light emitted by the light source 614 into a second spectrum of light and a second layer comprising a second fluorescing compound that converts the second spectrum of light and/or light that passes unaltered through the first layer into a third spectrum of light.

In one embodiment, at least a portion of the lens 632 may include a light absorbing dye or pigment that filters all or some of the light emitted by the light emitting device and/or that would otherwise be transmitted by the lens. For example, the lens may include a light absorbing dye or pigment that filters out light emitted by the light source 614 that is not converted into longer wavelength light. For example, the one or more fluorescing compounds may only be able to effectively convert a fraction of the light emitted by the light source 614 into the altered spectrum of light, with some of the original spectrum of light passing through the lens 632 unchanged. Filtering the component of transmitted light that remains unaltered might assist the practitioner in better visualizing defects in the targeted tissue by, e.g., reducing glare that might otherwise be caused by the unaltered light. In one embodiment, the lens 632 comprises a first layer through which light passes comprising one or more fluorescing compounds and a second layer through which light then passes comprising the light absorbing dye or pigment in order to filter light that remains unaltered after passing through the first layer.

In the case where the light source 614 emits ultraviolet light (approximately 300-400 nm), violet light (approximately 400-450 nm) and/or blue light (approximately 450-500 nm), the lens 632 may advantageously be adapted to convert such light into one or more of green light (approximately 500-550 nm), yellow light (approximately 550-600 nm), orange light (approximately 600-650 nm), or red light (approximately 650-700 nm). It is generally within the scope of the invention to provide a lens having a fluorescing compound that is able to convert any spectrum of light having a first wavelength into a second spectrum of light having a second wavelength longer than the first wavelength. The spectrum of light transmitted by the lens 632 may be monochromatic or within a range of wavelengths.

As a general rule, longer wavelengths of light are better able to illuminate and make visible certain oral tissues and/or defects contained therein. For example, green light has been found to be particularly useful in helping to detect the existence of plaque, calculus, tartar, or other impurities on the surface of a tooth. Yellow, orange and red light are particularly useful in detecting caries in a tooth, as well as diseases or other defects within soft oral tissues, such as soft tissues associate with a patient's gums, tongue or cheek. That is because longer wavelengths are better able to penetrate and thereby transilluminate healthy oral tissues. Defects typically block or scatter light in such a way as to make them more visible when surrounding healthy tissue is transilluminated.

The lens 632 may comprise any suitable material that is able to transmit light. A portion of the lens may also comprise a material that does not transmit light in order to reduce the size of the transmitted footprint of light. For example, the lens 632 may comprise or be manufactured using one or more of acrylic, polyacrylic, polypropylene, polycarbonate, silicone, aluminum dioxide, sapphire, quartz, glass, and the like. The lens 632 may be formed using any manufacturing process (e.g., molding, machining, or assembling).

It is within the scope of the invention to utilize any fluorescing compound that alters light in a suitable manner. An example of a class of fluorescing compound is fluorizine. A variety of fluorescing compounds sold under the trade name Edgeglo® are available from PolyOne Corporation. Examples of suitable Edgeglo® fluorescing colors include yellow, green, orange, and red.

FIG. 6B illustrates an exemplary embodiment of a tissue illumination apparatus 638 that includes a light emitting device 600 containing two LED light sources 614 and a lens 640 having a pair of focusing lenses 662 integrally formed therein. The lens 640 also includes one or more attachment structures 642 that aid in releasably attaching the lens 640 to the light emitting device 600.

FIG. 6C illustrates an exemplary embodiment of a tissue illumination apparatus 646 that includes a light emitting device 600 containing two LED light sources 614 and a conical tissue illumination lens 648. The conical lens 648 includes one or more attachment structures 650 that aid in releasably attaching the lens 648 to the light emitting device 600. Attachment structures 650 may include any other attachment structures (not shown) discussed above or known in the art. The conical lens 648 includes a pair of angled sidewalls 652 that extend from at or near the attachment structures 650 and converge at an apex 654.

FIG. 6D illustrates an exemplary embodiment of a tissue illumination apparatus 656 that includes a light emitting device 600, a conical lens 658, and a focusing lens 662. The light emitting device 600 includes an LED light source 614. The conical lens 658 includes one or more attachment structures 660 that aid in releasably attaching the lens 658 to the light emitting device 600. Attachment structures 660 may include any other attachment structures (not shown) discussed above or known in the art.

In one embodiment, at least a portion of the conical lens 658 includes or is coated with one or more fluorescing compounds that are able to convert shorter wavelength light emitted by the light sources 614 into longer wavelength light more suitable for visually observing defects in oral tissue. In another embodiment, at least a portion of the conical lens 658 may include or is coated with one or more light-absorbing pigments or dyes that are able to absorb at least some wavelengths or components of light emitted by the light source 614. The conical lens 658 may include any of the features discussed above relative to lens 632 of FIG. 6A. Because the focusing lens 662 may include one or more fluorescing compounds and/or one or more light-absorbing dyes or pigments, at least a portion of the conical lens 658 may be transparent and allow light to pass through unaltered.

The focusing lens 662 is interposed between the conical lens 658 and the light source 614 in order to capture and focus at least a portion of the light emitted by the light source 614. The focusing lens 662 is shown with a hemispherical configuration, although other configurations may be used (e.g., aspheric, convex, concave, and the like). In this embodiment, the focusing lens 662 is attached to the conical lens 658 by means of one or more attachment structures 664. The focusing lens 662 may be transparent or else impregnated, coated or otherwise treated with one or more fluorescing compounds and/or one or more light-absorbing dyes or pigments as discussed above with respect to other lenses. In one embodiment, where the focusing lens 662 contains a fluorescing compound that alters the wavelength of at least some of the light energy emitted by the light source 614, the conical lens 658 may be impregnated, coated or otherwise treated with one or more light-absorbing dyes or pigments that filter out a portion of the spectrum of light transmitted by the focusing lens 662 (e.g., light emitted by the light source 614 that passes through the focusing lens 662 unaltered).

FIG. 6E illustrates another alternative embodiment of a tissue illuminating apparatus 666 according to the invention, which includes a light emitting device 600, an outer lens 668, an inner lens 670, and a pair of focusing lenses 662. The light emitting device 600 includes a pair of LED or LED array light sources 614. The focusing lenses 662 are integrally or releasably attached to the light emitting device 600 by one or more attachment structures 676. The outer lens 668 is integrally or releasably attached to the focusing lenses 662 by one or more attachment structures 672.

In one embodiment, at least a portion of the outer lens 668 includes or is coated with one or more fluorescing compounds that are able to convert shorter wavelength light emitted by the light sources 614 into longer wavelength light more suitable for visually observing defects in oral tissue. In another embodiment, at least a portion of the outer lens 668 may include or is coated with one or more light-absorbing pigments or dyes that are able to absorb at least some wavelengths or components of light emitted by the light source 614. The outer lens 668 may include any of the features discussed above relative to lens 632 of FIG. 6A. Because either the focusing lenses 662 or inner lens 670 may include one or more fluorescing compounds and/or one or more light-absorbing dyes or pigments, at least a portion of the outer lens 668 may be transparent and allow light to pass through unaltered. In the alternative, because the outer lens 668 has an opening at an end thereof through light may pass unimpeded or unaltered by the outer lens 668, at least a portion of the outer lens 668 may be entirely opaque to some or all wavelengths of light in order to reduce the size of the footprint of light passing through the outer lens 668.

The focusing lenses 662 are interposed between the outer lens 668 and the light sources 614 in order to capture and focus at least a portion of the light emitted by the light sources 614. In one embodiment, each focusing lens 662 captures and focuses at least a portion of the light emitted by a corresponding light source 614. The focusing lenses 662 may be transparent or else impregnated, coated or otherwise treated with one or more fluorescing compounds and/or one or more light-absorbing dyes or pigments as discussed above with respect to other lenses. In one embodiment, where one or both of the focusing lenses 662 contain a fluorescing compound that alters the wavelength of at least some of the light energy emitted by the light sources 614, at least a portion of the outer lens 668 may be impregnated, coated or otherwise treated with one or more light-absorbing dyes or pigments that filter out a portion of the spectrum of light transmitted by the focusing lenses 662 (e.g., light emitted by the light sources 614 that passes through the focusing lenses 662 unaltered).

The inner lens 670 is disposed within an interior chamber or cavity defined by the outer lens 668. The inner lens 670 may be transparent or else impregnated, coated m or otherwise treated with one or more fluorescing compounds and/or one or more light-absorbing dyes or pigments as discussed above with respect to other lenses. In one embodiment, where one or both of the focusing lenses 662 contain a fluorescing compound that alters the wavelength of at least some of the light energy emitted by the light sources 614, at least a portion of the inner lens 670 may be impregnated, coated or otherwise treated with one or more light-absorbing dyes or pigments that filter out a portion of the spectrum of light transmitted by the focusing lenses 662 (e.g., light emitted by the light sources 614 that passes through the focusing lenses 662 unaltered).

The inner lens 670 further includes a light emitting tip 678 adjacent to the opening or cavity at the end of the outer lens 668 through which at least of portion of the light that enters the inner lens 670 may exit. In the case where the outer lens 668 is opaque or otherwise blocks some or all of the light emitted by the light sources 614, the footprint of light that emerges from the outer lens 668 will be defined by the size of the opening or cavity at the end of the outer lens 668. A small footprint of light may be useful in some situations because it reduces light energy output that might otherwise be so overpowering as to cause glare to the dental practitioner. The inner lens 670 may optionally comprises a flexible or resilient material in order to cushion the tissue illumination apparatus 666 if placed directly against oral tissue.

It will be appreciated that the foregoing lens designs are merely exemplary. It should be understood that any of the features of one lens described herein can be interchanged or supplemented with one or more other features described herein for any other lens or lenses.

It will also be appreciated that the present claimed invention may be embodied in other specific forms without departing from its spirit or essential characteristics. The described embodiments are to be considered in all respects only as illustrative, not restrictive. The scope of the invention is, therefore, indicated by the appended claims rather than by the foregoing description. All changes that come within the meaning and range of equivalency of the claims are to be embraced within their scope.

What is claimed is:

1. A light emitting system, comprising:
a light emitting device that includes a light emitting end;
a light source disposed at the light emitting end of the light emitting device comprising at least one LED or LED array configured to selectively provide an output of light upon activation of the light emitting device; and
at least one lens releasably attached to the light emitting end of the light emitting device, the lens being adapted to alter or transmit the output of light in a desired manner.

2. A light emitting system as defined in claim 1, wherein the lens comprises at least one protective lens.

3. A light emitting system as defined in claim 2, wherein the protective lens has a first end that is substantially flat proximal to the light source through which light emitted by the light source enters and a second end that is substantially flat distal to the light source through which light that enters the protective lens exits.

4. A light emitting system as defined in claim 2, wherein at least a portion of the protective lens has a conical shape.

5. A light emitting system as defined in claim 2, wherein at least a portion of the protective lens comprises a hollow cone.

6. A light emitting system as defined in claim 1, wherein the lens comprises at least one focusing lens.

7. A light emitting system as defined in claim 6, wherein the focusing lens comprises at least one diffusing lens adapted to diffuse light emitted by the light source.

8. A light emitting system as defined in claim 6, wherein the focusing lens comprises at least one collimating lens adapted to collimate light emitted by the light source.

9. A light emitting system as defined in claim 8, wherein the collimating lens comprises at least one of a spherical, hemispherical, or aspherical lens.

10. A light emitting system as defined in claim 1, wherein the lens comprises a spot curing lens.

11. A light emitting system as defined in claim 10, wherein the spot curing lens comprises a wall that is opaque to at least some wavelengths of light emitted by the light source.

12. A light emitting system as defined in claim 10, wherein the spot curing lens comprises at least one focusing lens associated therewith.

13. A light emitting system as defined in claim 1, wherein the lens comprises at least one tissue illumination lens that includes at least one fluorescing compound that converts light energy emitted by the light source into light energy having a longer average wavelength.

14. A light emitting system as defined in claim 13, wherein the fluorescing compound comprises at least one fluorizine compound.

15. A light emitting system as defined in claim 13, wherein the tissue illumination lens further comprises at least one dye or pigment that absorbs a portion of light emitted by the light source.

16. A light emitting system as defined in claim 1, wherein the lens comprises at least two different types of lenses selected from protective lenses, focusing lenses, spot curing lenses, and tissue illumination lenses.

17. A light emitting system, comprising:
a light emitting device that includes a light emitting end;
a light source disposed at the light emitting end of the light emitting device comprising at least one LED or LED array configured to selectively provide an output of light upon activation of the light emitting device; and
at least one of a protective lens, a focusing lens, a spot curing lens, or a tissue illumination lens releasably attached to the light emitting end of the light emitting device.

18. A light emitting kit, comprising:
at least one light emitting device that includes a light emitting end;
a light source disposed at the light emitting end of the light emitting device comprising at least one LED or LED array configured to selectively provide an output of light upon activation of the light emitting device; and
at least one lens that is designed so as to be releasably attachable to the light emitting end of the light emitting device, the lens being adapted to alter or transmit the output of light in a desired manner when attached to the light emitting device.

19. A light emitting kit as defined in claim 18, wherein the lens comprises at least one of a protective lens, a focusing lens, a spot curing lens, or a tissue illumination lens.

20. A light emitting kit as defined in claim 18, wherein the kit comprises at least two different types of interchangeable lenses selected from protective lenses, focusing lenses, spot curing lenses, and tissue illumination lenses.

21. A light emitting kit, comprising:
at least one light emitting device that includes a light emitting end;
a light source disposed at the light emitting end of the light emitting device comprising at least one LED or LED array configured to selectively provide an output of light upon activation of the light emitting device; and
a plurality of interchangeable lenses comprising at least one of a protective lens, a focusing lens, a spot curing lens, or a tissue illumination lens and designed so as to be releasably attachable to the light emitting end of the light emitting device.
